(19) United States
(12) Patent Application Publication
(10) Pub. No.: US 2007/0230732 A1
(43) Pub. Date: Oct. 4, 2007

(54) Ceramic-Type Loudspeaker

(76) Inventors: Taiji Matsufuji, Tokyo (JP); Harumitsu Kato, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/597,946

(22) PCT Filed: Oct. 21, 2005
(86) PCT No.: PCT/JP05/19429

§ 371 Date: Nov. 29, 2006

(30) Foreign Application Priority Data
Oct. 25, 2004 (JP) 2004-310063
Oct. 25, 2004 (JP) 2004-310065

(51) Int. Cl. H04R 1/02

(52) U.S. Cl. 381/332

(57) ABSTRACT

A ceramic-type loudspeaker is provided which can be disposed in any position without marring (spoiling) the design of a room where this loudspeaker is installed and without imposing restrictions on environmental conditions. The ceramic-type loudspeaker which is driven by a drive unit that outputs an audio signal includes: a speaker driver 50 which is formed by electrically connecting a primary winding 54 of a second transformer 46 in series with a secondary winding 53 of a first transformer 45 in which an audio signal is inputted from the drive unit; and a serial-parallel circuit portion 69 which is formed by connecting a plurality of series circuits in parallel, the plurality of series circuits being formed by connecting, in series, first, second ceramic vibrators 25, 26 and third, fourth ceramic vibrators 27, 28 which are driven through an audio signal from a secondary winding 56 of the second transformer 46 of the speaker driver 50. The speaker driver 50 makes an impedance match between the drive unit and the serial-parallel circuit portion 69.

### TECHNICAL FIELD

The present invention relates to a ceramic-type loudspeaker, and particularly, a ceramic-type loudspeaker which is attached mainly to a ceiling surface or a wall surface of a building and is used for indoor ordinary broadcasting (i.e., general sound and voice) or emergency addressing.

### BACKGROUND ART

Conventionally, in a room of a building or the like as a construction structure, a loudspeaker is installed for general audio broadcasting, background music or emergency addressing. This kind of loudspeaker used as broadcasting equipment inside of a building is mainly a dynamic-type loudspeaker, which is designed to output a sound by vibrating a cone paper using a magnet (e.g., refer to Japanese Patent Laid-Open No. 07-098982 specification or another document). However, such a dynamic-type loudspeaker has a disadvantage in that its whole exterior appears on the inside of a room, thereby spoiling the room's appearance and design (i.e., interior decoration). It has another disadvantage in that depending upon environmental conditions where the loudspeaker is installed, harsh restrictions on the loudspeaker's installation place may be imposed, taking into account how to protect it against dust or water.

Therefore, for example, a piezoelectric vibrator is known in which a ceiling surface or a wall surface in a room is used as an acoustic diaphragm. When this piezoelectric vibrator vibrates, the room's ceiling surface or wall surface is vibrated so that a sound is outputted. This makes it possible to install and use the piezoelectric vibrator on the inside of a ceiling surface or a wall surface. As a result, the piezoelectric vibrator would not mar the room's appearance and design. Besides, restrictions would be relaxed on where the piezoelectric vibrator should be installed (e.g., refer to Japanese Patent Laid-Open No. 2000-224680 specification or another document).

Patent Document 1: Japanese Patent Laid-Open No. 07-098982 specification

Patent Document 2: Japanese Patent Laid-Open No. 2000-224680 specification

### DISCLOSURE OF THE INVENTION

### Problems to be Solved by the Invention

However, the above described piezoelectric vibrator has the following disadvantages. For example, in an emergency address system or a regular broadcasting system, in order to secure a specific sound level, two piezoelectric vibrators are often connected in series. Then, two such sets are used, and both are connected in parallel with each other. In this case, in order to secure a required voltage in the piezoelectric vibrators, if a 100-volt audio signal is directly used by grounding them on reinforced concrete or the like, then heat may be generated in the reinforced concrete or the like, thus setting the building on fire.

In addition, if the audio signal is dropped to 70 volts by a transformer and this voltage is applied to two series piezoelectric vibrators, then a voltage of 35 volts is given to each piezoelectric vibrator. Thereby, a required sound-pressure level is secured, but a required impedance cannot be obtained (i.e., impedance mismatching). Besides, if the transformer is used, then because of its great thickness, the apparatus which includes the piezoelectric vibrators becomes thicker. This requires a larger space for its installation. Particularly, since the space between two wall materials is standardized usually as 45 mm, this thicker apparatus including the piezoelectric vibrators cannot be attached at all to the interior surface of a wall.

In order to realize impedance matching, an impedance such as a resister can be provided on the outside of a parallel circuit which includes the piezoelectric vibrators. However, in this case, the voltage applied to a single piezoelectric vibrator becomes too low, so that can not secure the required sound-pressure level.

Therefore, a technical problem to be solved arises, aiming to install the above described loudspeaker in any position without harming the appearance and design of the face of a room where this loudspeaker is installed and without imposing restrictions on environmental conditions. In addition, another technical problem to be solved is raised, for the purpose of satisfying the conditions simultaneously for making an impedance match, securing a required voltage and making a matching transformer thinner. Hence, it is an object of the present invention to resolve these problems.

### Means for Solving the Problems

The present invention is proposed to attain the above described object, and thus, a ceramic-type loudspeaker according to claim 1, characterized by including: a speaker driver which is formed by electrically connecting the primary side of a second transformer in series with the secondary side of a first transformer in which an audio signal is inputted from the drive unit; and a serial-parallel circuit portion which is formed by connecting a plurality of series circuits in parallel, the plurality of series circuits being formed by connecting, in series, ceramic vibrators driven through an audio signal from the secondary side of the second transformer of the speaker driver, the speaker driver making an impedance match between the drive unit and the serial-parallel circuit portion.

According to this configuration, an audio signal V0 (e.g., 100 volts) outputted from the drive unit is first transformed into a voltage V1 by the first transformer. Next, it is transformed into a voltage V2 by the second transformer. Therefore, if the ratio of the first transformer's primary winding to its secondary winding in terms of the number of windings (i.e., a first winding ratio), and the ratio of the second transformer's primary winding to its secondary winding in terms of the number of windings (i.e., a second winding ratio), are properly varied, then a power-supply voltage V2 is obtained which is necessary for the ceramic vibrators of the serial-parallel circuit portion. At the same time, the transformation of an impedance is also regulated, so that there is no need to provide a resister R or the like for impedance matching.

A ceramic-type loudspeaker according to claim 2 is provided which is characterized in that, in the ceramic-type loudspeaker according to claim 1, the first transformer and the second transformer are housed in a speaker case, and both transformers are disposed in places different from each other on the same plane of the speaker case.

According to this configuration, the first transformer and the second transformer are separately disposed at two places on the interior surface of the speaker case. This helps halve the thickness of the speaker case, compared with the case where both are disposed in piles.

A ceramic-type loudspeaker according to claim 3 is provided which is characterized in that, in the ceramic-type loudspeaker according to claim 2, the speaker case is disposed in a building material of a building, each ceramic vibrator is attached to the inside of the front portion of the speaker case, the speaker driver is attached to the inside of the back portion of the speaker case, and the front portion of the speaker case is attached to the building material.

According to this configuration, the ceramic vibrators are disposed inside of the front portion of the speaker case. Then, this case's front portion is glued and attached to a building material, such as a ceiling material, a wall material and a pane of glass of a building. After it is attached, if the speaker driver drives the ceramic vibrators, a vibration sound outputted from the ceramic vibrators is uniformly transmitted all over the building's inside through the building material's surface. In this case, the building material itself functions as the loudspeaker's diaphragm. Besides, the loudspeaker is disposed on the backside of the building material, so that the loudspeaker is invisible to a person who stays on the side of the building material's surface.

A ceramic-type loudspeaker according to claim 4 is provided which is characterized in that, in the ceramic-type loudspeaker according to claim 3, the front portion of the speaker case is attached to the building material, using a double-faced adhesive tape.

According to this configuration, when attached to the building material, the loudspeaker is fitted by only gluing the speaker case's front portion to the building material, by means of a double-faced adhesive tape.

A ceramic-type loudspeaker according to claim 5 is provided which is characterized in that, in the ceramic-type loudspeaker according to any one of claims 2 to 4, the ceramic vibrators are individually disposed in a plurality of places inside of the front portion of the speaker case.

According to this configuration, a plurality of such ceramic vibrators are disposed in a plurality of places on the speaker case's interior surface. Therefore, the speaker case becomes thinner than in the case where they are piled in one and the same place.

### Advantages of the Invention

In the ceramic-type loudspeaker according to claim 1, different from the case where a single transformer is used, an impedance match can be easily made. Simultaneously, without increasing the number of its component parts, the voltage can be freely transformed to a desirable voltage. Furthermore, the power consumption is reduced to approximately one-third that of the case where a single transformer is used. At the same time, the usable frequency band becomes wider. Moreover, an impedance match can be made without providing midway a resister R for impedance matching. This helps make the circuit configuration simpler and the loudspeaker thinner, so that it can be easily installed between walls only a small distance away from each other. In addition, even if the loudspeaker is continuously in operation for a long time, then because the resister R is not used, heat is not generated so that the building can be prevented from catching fire. Besides, an improvement can be realized in the characteristic relation between a sound-pressure level and a frequency. This makes it possible to secure a sound-pressure level easily within a predetermined band.

In the ceramic-type loudspeaker according to claim 2, the speaker case's thickness becomes smaller. Hence, in addition to the advantages according to claim 1, the ceramic-type loudspeaker itself can be thinned. This helps install it within a smaller space.

In the ceramic-type loudspeaker according to claim 3, the loudspeaker is provided on the rear-surface side of a building material in a building. Thereby, the loudspeaker cannot be seen by a person who stays indoors. Hence, in addition to the advantages according to claim 2, the appearance and design inside of the room become far better. Furthermore, when the loudspeaker is placed in a building material, there is no need to make a hole in the building material. Therefore, its installation can be conducted well, and particularly, when it is placed in a building material already provided, its work can be extremely easily carried out. Moreover, the ceramic vibrators and the speaker driver are housed in the speaker case. Therefore, compared with any conventional loudspeaker, it is superior in dust-proofing, waterproofing and impact-resistance. This makes it possible to install the loudspeaker in a arbitrary position without restriction on the environment in which the loudspeaker is placed.

In the ceramic-type loudspeaker according to claim 4, the loudspeaker can be attached by only sticking the speaker case's front portion onto the building material's back surface, using a double-faced adhesive tape. Hence, in addition to the advantages according to claim 3, when the loudspeaker is attached, there is no need to use metal fittings for attachment, or the like. Therefore, the loudspeaker can be attached easily and swiftly, thereby cutting down the cost of installing it.

In the ceramic-type loudspeaker according to claim 5, the speaker case becomes thinner. Hence, in addition to the advantages according to claim 3 or 4, the loudspeaker becomes thinner as well. This helps install the loudspeaker between building materials only a small distance away from each other, for example, between a ceiling board and a base board.

### BRIEF DESCRIPTION OF THE DRAWINGS

FIG. 1 is a plan view of a loudspeaker according to an embodiment of the present invention and a building material, showing a position in which the loudspeaker is attached.

FIG. 2 is a front view of a housing case of the loudspeaker of FIG. 1.

FIG. 3 is a rear view of the housing case of the loudspeaker of FIG. 1.

FIG. 4 is a side view of the housing case of the loudspeaker of FIG. 1.

FIG. 5 is a sectional view of the housing case, seen along the A-A line of FIG. 3.

FIG. 6 is a front view of a vibrator attachment-side housing portion which forms a part of the housing case of FIG. 2, showing its interior-surface configuration.

FIG. 7 is a sectional view of the housing case, seen along the B-B line of FIG. 2.

FIG. 8(a) is an enlarged front view of a ceramic vibrator housed in the housing case of FIG. 2. FIG. 8(b) is a sectional view of the ceramic vibrator, seen along the C-C line.

FIG. 9 is a side view of the ceramic vibrator (including a connector) of FIG. 8.

FIG. 10 is a front view of a transformer attachment-side housing portion which forms a part of the housing case of FIG. 2, showing its interior-surface configuration.

FIG. 11 is a circuit wiring diagram, showing a drive circuit of the loudspeaker according to the embodiment of the present invention.

FIG. 12 is a perspective view of the loudspeaker of FIG. 1, showing a state in which it is attached to a ceiling portion.

FIG. 13 is a front view of the loudspeaker of FIG. 1, showing a state in which it is attached to a wall-surface portion.

FIG. 14 is a front view of the loudspeaker of FIG. 1, showing a state in which it is attached to a glass portion.

FIG. 15 is a graphical representation, showing a characteristic relation between the sound-pressure level and the frequency of the loudspeaker of FIG. 1.

FIG. 16 is a graphical representation, showing another characteristic relation between the sound-pressure level and the frequency of the loudspeaker of FIG. 1.

### BEST MODE FOR IMPLEMENTING THE INVENTION

According to the present invention, a second transformer is connected in series with the secondary side of a first transformer in which an audio signal is inputted, and this audio signal's level is transformed by two steps. Thereby, the object can be attained of simultaneously satisfying the requirements for making an impedance match, securing a predetermined voltage and thinning a matching transformer.

In addition, according to the present invention, in the loudspeaker disposed in a building material, the ceramic vibrators are attached to the inside of the speaker case's front portion. Then, the speaker driver which drives the ceramic vibrators is attached to the inside of the speaker case's rear portion. Sequentially, the front portion of the speaker case is glued to the building material's back surface. Thereby, the object can be attained of installing the loudspeaker in a desirable position without marring the appearance and design of a surface inside of a room.

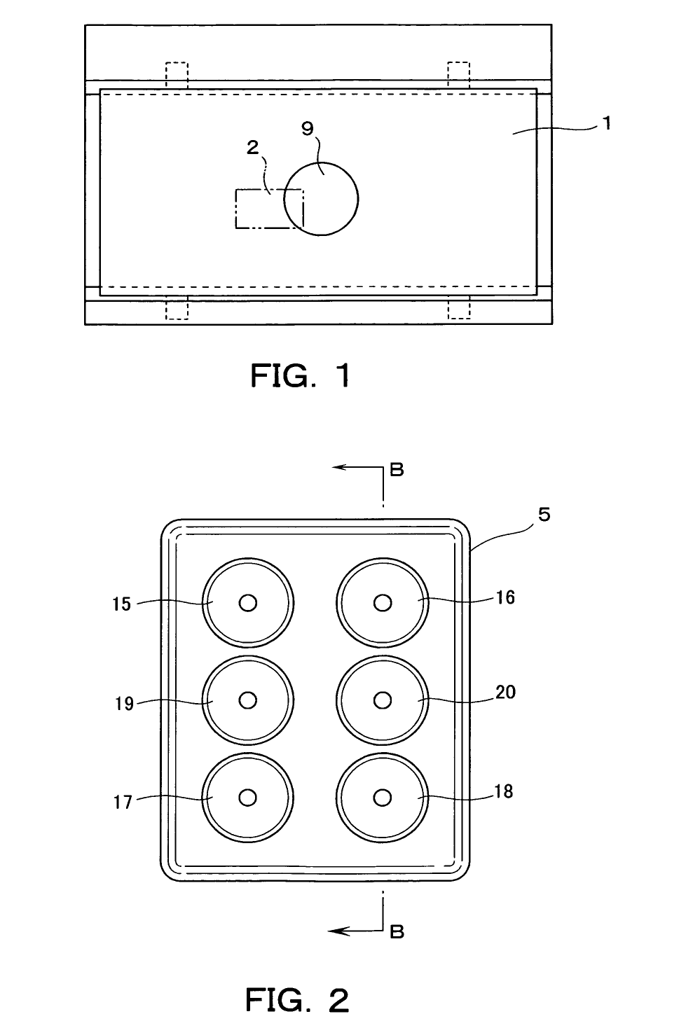

Hereinafter, a ceramic-type loudspeaker according to an embodiment of the present invention will be described with reference to FIG. 1 to FIG. 16. In FIG. 1, reference numeral 1 denotes a building material which forms a part of the ceiling or the like of a building structure, such as an office building, a school, a hospital, a housing complex and a city hall. At a place slightly apart from a middle (center) portion 9 on the building material's 1 back surface is attached an enclosed ceramic-type loudspeaker (a ceramic-board speaker unit) 2. The building material 1 to which the ceramic-type loudspeaker 2 is attached may be made of either metal or nonmetal, as long as it is a board which can be vibrated. The ceramic-type loudspeaker 2 is not shown in the figure, but for example, it is driven by a drive unit such as an amplifier which outputs a 100-volt audio signal.

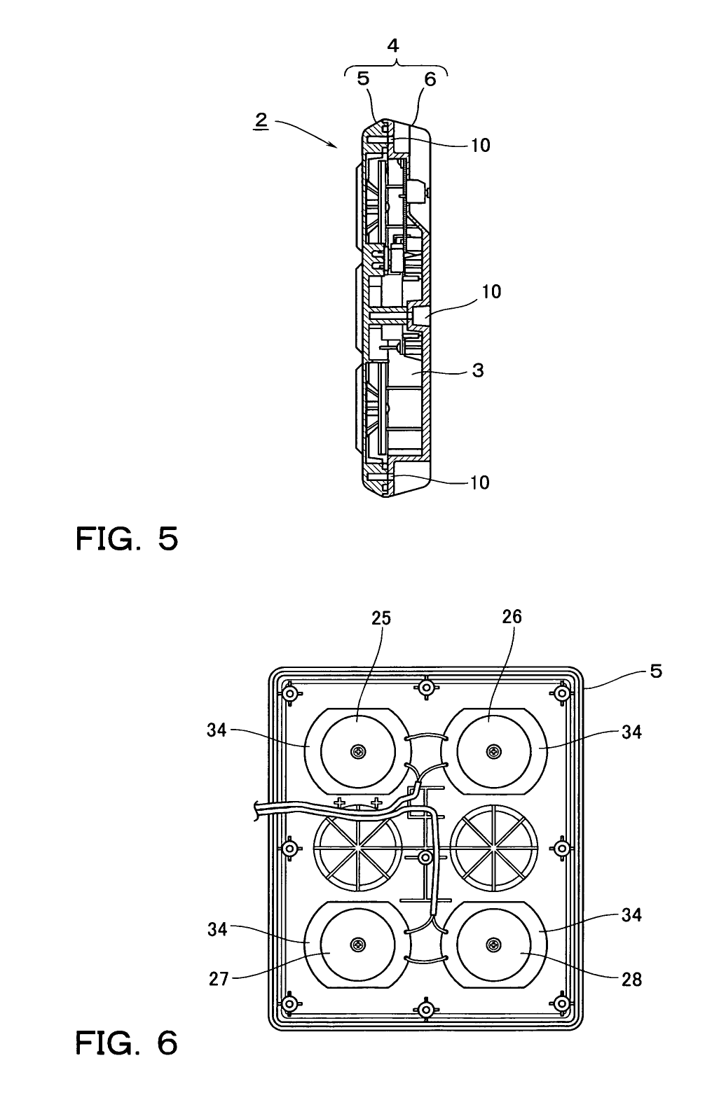

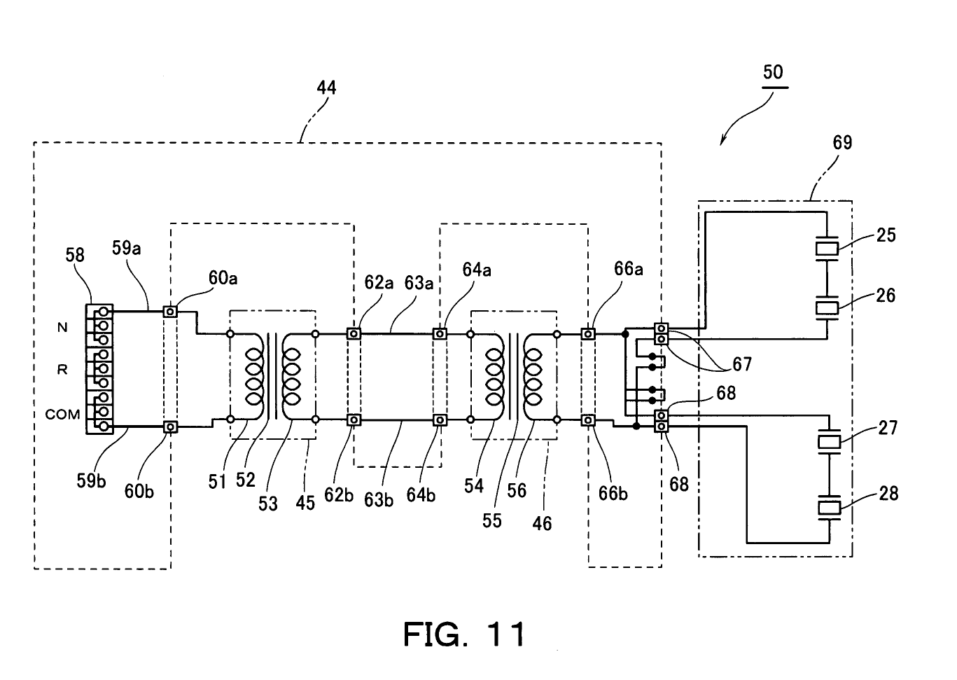

The ceramic-type loudspeaker 2 includes: a housing case 4 of FIG. 4; first to fourth ceramic vibrators 25 to 28 of FIG. 6 which are housed in a speaker-driver housing space portion 3 of FIG. 5 formed in the housing case 4; a printed wiring board 44 shown in FIG. 10 which is also housed in the speaker-driver housing space portion 3; a first matching transformer 45; and a second matching transformer 46. The printed wiring board 44 and the first, second matching transformers 45, 46 make up a speaker driver 50 shown in FIG. 11.

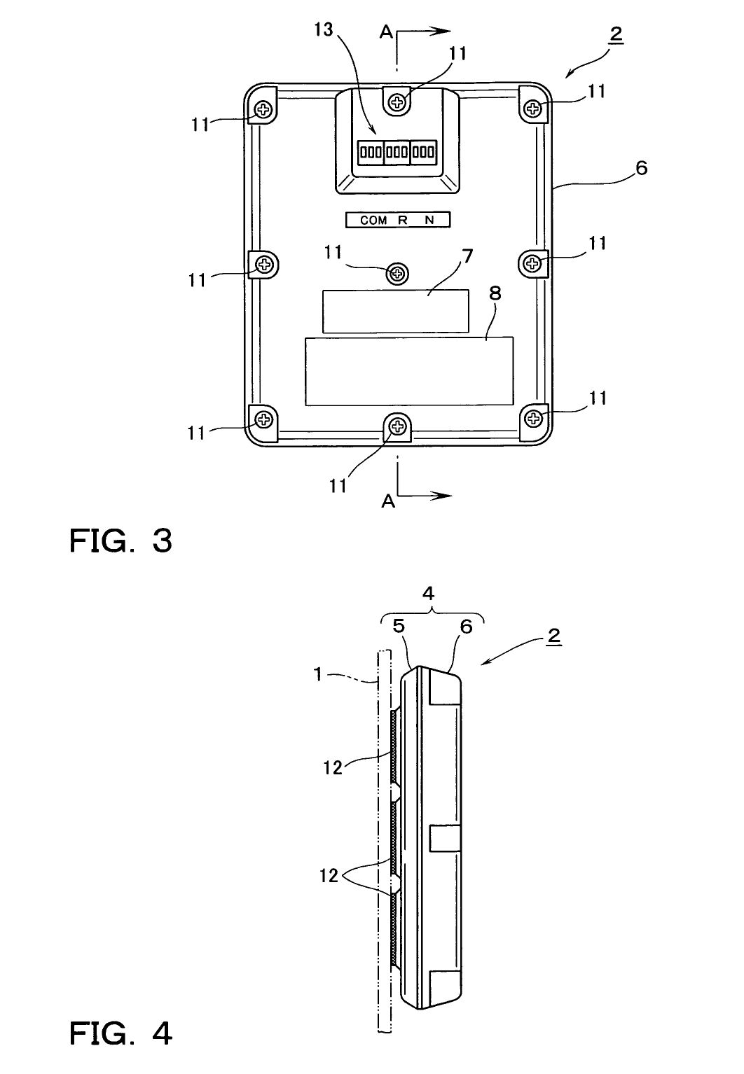

The housing case 4 of the ceramic-type loudspeaker 2 is molded out of a heat-resistant resin (e.g., an ABS resin). This housing case 4 is formed by a front-side (vibrator attachment-side) housing portion 5 shown in FIG. 2 and a back-side (transformer attachment-side) housing portion 6 shown in FIG. 3. In the back-side housing portion 6, a rated-value indication label 7 and a caution-item indication label 8 are affixed on its exterior surface. The partial portion of the housing case 4 functions as the baffle plate of such an enclosed-type loudspeaker.

In both housing portions 5, 6, as illustrated in FIG. 5, a plurality of screw holes 10 are formed in their corners, in the middles of their sides and in the centers. Into each screw hole 10, a connection screw 11 (see FIG. 3) is driven, and thereby, the front-side housing portion 5 and the back-side housing portion 6 connect so as to be attached to, or detached from, each other. Besides, as shown in FIG. 4, using a double-faced adhesive tape 12, the outside surface of the front-side housing portion 5 is stuck to the building material's 1 back surface. Thereby, the ceramic-type loudspeaker 2 is united to the building material 1. In FIG. 3, reference numeral 13 designates a crimp connector (crimp contact) which is connected to the printed wiring board 44. A power-supply cable, a signal-tone cord or the like is connected thereto so that they can be attached or removed.

In the front of the front-side housing portion 5, in other words, in its bottom part, as shown in FIG. 2, six circular convex portions 15 to 20 in total which jut out from this front-side housing portion 5 are provided in two rows and in three tiers. Specifically, in FIG. 2, the two circular convex portions 15, 16 protrude in the upper tier; the two circular convex portions 17, 18, in the lower tier; and the two circular convex portions 19, 20, in the middle tier. The surfaces of these circular convex portions 15 to 20 are flat so as to be attached to the building material's 1 back surface. The above described double-faced adhesive tape 12 is stuck on them. This makes the attachment work better than the case where a double-faced adhesive tape is placed over the whole front surface of the front-side housing portion 5. Specifically, if a double-faced adhesive tape is stuck on the entire front surface of the front-side housing portion 5, the double-faced adhesive tape occupies too large an area. Thus, when it is stuck, air tends to come in to form a bubble. In order to prevent this, a worker has to handle them with tremendous care. However, as is the case with this embodiment, if the circular convex portions 15 to 20 are the surfaces for such attachment, the sticking surface is supposed to be divided. Therefore, a bubble is hard to form between the glued surfaces, thus making the attachment work easier. Besides, as described later, the circular convex portions 15 to 18 near the four corners are designed to be the vibrator attachment portions 21 to 24 to which the ceramic vibrators 25 to 28 are attached. This makes it possible to transmit the vibration of the first to fourth ceramic vibrators 25 to 28, without any loss and with precision, to the building material 1.

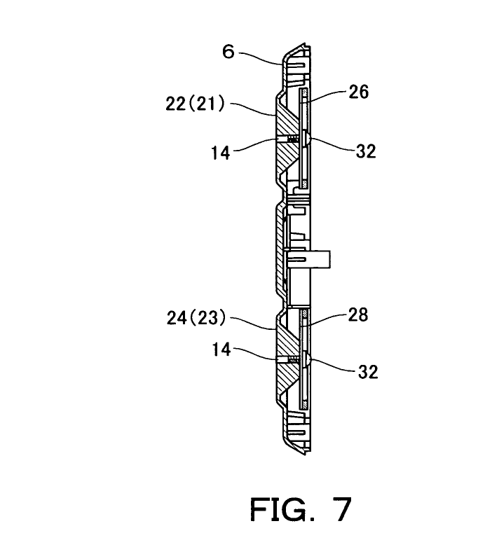

On the inside of the circular convex portions 15 to 18 near the four corners of the front-side housing portion 5, as shown in FIG. 7, the vibrator attachment portions 21 to 24 which each have a screw through hole 14 are disposed, respectively. To the vibrator attachment portions 21 to 24, the first to fourth ceramic vibrators 25 to 28 which are first to fourth bimorph-type ceramic vibrators are attached so as to be freely attached or detached. The first to fourth vibrators 25 to 28 are created by sticking a ceramic element (shaped like a disk) such as PZT (lead zirconate titanate) which has a piezoelectric vibration capability, onto both surfaces of a circular metal plate (made of an alloy of Fe-42% Ni). Between the ceramic element and the metal plate, an audio signal is given, so that this audio signal is transformed into a vibration. The material of the first to fourth vibrators 25 to 28 is not limited to this, and thus, another kind of piezoelectric vibrator element can be used.

The first ceramic vibrator 25 and the second ceramic vibrator 26 are connected mutually in series. In the same way, the third ceramic vibrator 27 is connected mutually in series with the fourth ceramic vibrator 28. Then, the first, second ceramic vibrators 25, 26 are connected, as shown in FIG. 6 and FIG. 11, mutually in parallel with the third, fourth ceramic vibrators 27, 28.

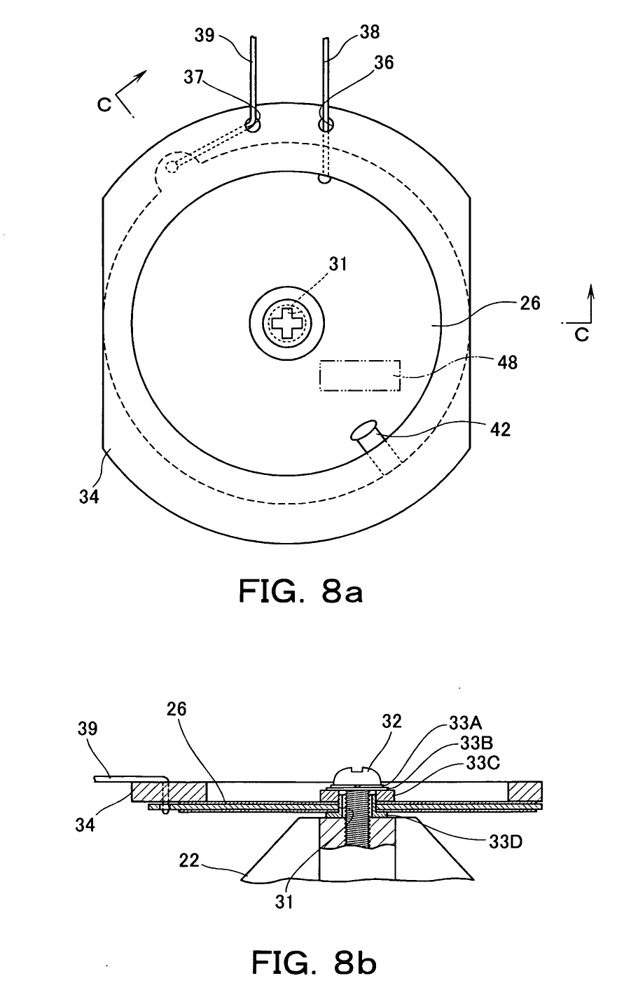

The first to fourth vibrators 25 to 28 all have the same attachment structure and lead-wire connection structure. Hence, a description will be given below by illustrating the structure of the second ceramic vibrator 26. As shown in FIG. 8, an attachment hole 31 is made in the central part of the second ceramic vibrator 26. Into this attachment hole 31, a machine screw 32 is driven, as shown in FIG. 7. By means of the machine screw 32, the second ceramic vibrator 26 is clamped on the inside of the circular convex portion 16 of the front-side housing portion 5, so that it can be attached and detached.

Furthermore, between the bearing surface of the machine screw 32 and the second ceramic vibrator 26, a spring washer 33A, a plain washer 33B, a washer 33C for ceramics are placed in order. Besides, between the second ceramic vibrator 26 and the vibrator attachment portion 22, a bush 33D for ceramics are placed in sequence. This helps prevent an excessively great clamping force from being applied to the second ceramic vibrator 26.

Moreover, in the second ceramic vibrator 26, as shown in FIG. 8, a rubber damper (which is an elastic body) 34 is glued to its circumferential-rim part. This rubber damper 34 has two arc portions which face each other, and two parallel straight-line portions which link both ends of the two arc portions. The two straight-line portions extend in the directions tangential to the circular rim part of the second ceramic vibrator 26.

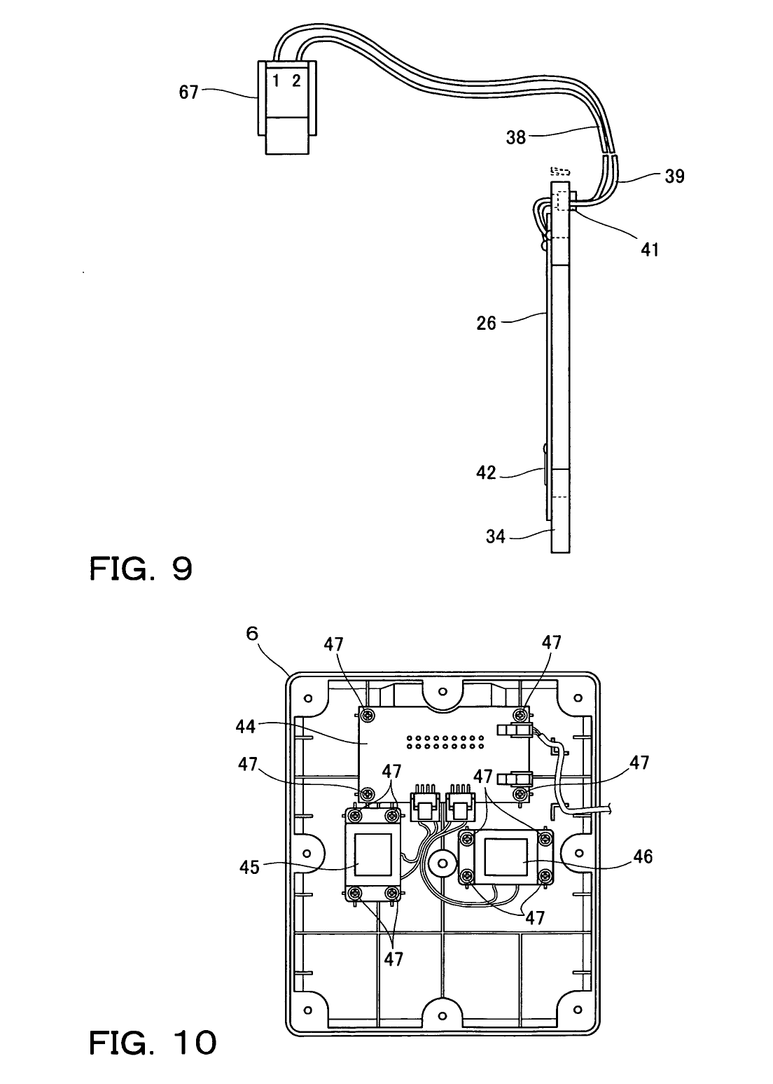

In the middle part of an arc portion of the rubber damper 34, two holes 36, 37 for clamping a lead wire are formed side by side. Lead wires 38, 39 pass through the holes 36, 37, respectively. One end of the lead wire 38 is connected to one of the two disk-shaped ceramic elements which make up a part of the second ceramic vibrator 26. On the other hand, one end of the lead wire 39 is connected to a disk-shaped metal plate which makes up a part of the second ceramic vibrator 26 and both sides of which are attached and fixed to the two ceramic elements. The other ends of the lead wires 38, 39 are connected, as shown in FIG. 9, to a crimp connector 67 (described later).

The parts at which the lead wires 38, 39 penetrate the rubber damper 34 are fixed, using a hardening silicone 41, to the second ceramic vibrator 26 and the rubber damper 34. Onto the lower surface of the second ceramic vibrator 26, a filmy jumper wire 42 which extends in its radius directions is fixed in an appropriate position, so that the ceramic elements fixed on both sides of the metal plate can be connected. Thereby, an audio signal is inputted between each of the two ceramic elements and the metal plate, and thus, the ceramic vibrator 26 is vibrated. In FIG. 8, reference numeral 48 denotes a manufacturing secret-number indication portion which is provided on the surface of the second ceramic vibrator 26.

As shown in FIG. 10, on the interior-surface side of the back-side housing portion 6, there are disposed the printed wiring board 44, the first matching transformer 45 and the second matching transformer 46. These printed wiring board 44 and first, second matching transformers 45, 46 are each fixed, by means of fixing screws 47, to a support portion which protrudes from the interior surface of the back-side housing portion 6.

FIG. 11 is a circuit wiring diagram, showing the speaker driver 50 which includes the printed wiring board 44, the first, second matching transformers 45, 46 and the first to fourth ceramic vibrators 25 to 28. As shown in this figure, the first matching transformer 45 is made up of a primary winding 51, an core 52 and a secondary winding 53. Similarly, the second matching transformer 46 is made up of a primary winding 54, an core 55 and a secondary winding 56.

The first matching transformer 45 and the second matching transformer 46 are connected in series, as well as the secondary winding 53 of the first matching transformer 45 is designed to have substantially the same number of turns as that of the primary winding 54 of the second matching transformer 46. Then, the first matching transformer 45 and the second matching transformer 46 part to right and left at two places on the same interior surface of the housing case 4.

On the printed wiring board 44, a one-touch terminal block 58 is provided, and the pattern wiring portion of the printed wiring board 44 is connected to one side of this one-touch terminal block 58. To the other side of the one-touch terminal block 58, lead wires 59a, 59b are connected, and crimp connectors 60a, 60b are provided at the ends of the lead wires 59a, 59b, respectively.

To the crimp connectors 60a, 60b are connected both ends of the primary winding 51 of the first matching transformer 45. Then, both ends of the secondary winding 53 of the first matching transformer 45 are connected, via crimp connectors 62a, 62b, cables 63a, 63b and crimp connectors 64a, 64b, to both ends of the primary winding 54 of the second matching transformer 46.

In addition, both ends of the secondary winding 56 of the second matching transformer 46 are connected to crimp connectors 66a, 66b. Between both crimp connectors 66a, 66b, a serial-parallel circuit portion 69 is connected via a pair of crimp connectors 67 and a pair of crimp connectors 68. This serial-parallel circuit portion 69 is a circuit portion in which the series circuit of the above described first, second ceramic vibrators 25, 26 and the series circuit of the above described third, fourth ceramic vibrators 27, 28 are disposed in parallel.

In the speaker driver 50 which has such connections as described above, the ratio of the impedance of the primary winding 51 of the first matching transformer 45 to that of its secondary winding 53 is approximately 10:7. On the other hand, the ratio of the impedance of the primary winding 54 of the second matching transformer 46 to that of its secondary winding 56 is set to be about 10:5. The impedance of each coil (winding) 51, 53, 54, 56 can be set by suitably changing the diameter of a coil material and the number of turns.

A 100-volt audio signal V0 supplied to the ceramic-type loudspeaker 2 is first transformed, by the first matching transformer 45, into an audio voltage V1 of around 70 volts which is lower than the audio signal V0. Next, it is transformed, by the second matching transformer 46, into an audio voltage of some 50 volts V2 which is far lower than the audio signal V0. Therefore, the applied voltage of each of the first to fourth ceramic vibrators 25 to 28 is 24.5 volts, so that a required sound-pressure level is obtained. In this case, there is no need to provide a resister R for impedance matching. In sum, an impedance match can be made, and at the same time, a 100-volt audio signal is transformed into 24.5 volts so that a practicable sound-pressure level can be outputted. Besides, the power consumption is reduced to approximately one-third that of a conventional case where a single transformer is used, and simultaneously, the usable frequency band becomes wider.

Furthermore, the first matching transformer 45 and the second matching transformer 46 separate from each other in two positions on the interior surface of the housing case 4. Therefore, the case thickness becomes half, compared with the case where the first, second matching transformers 45, 46 are piled. This helps lighten and thin the ceramic-type loudspeaker 2 (e.g., a total weight of 680 grams and a size of 176×210×40 mm). In general, wall materials are some 45 mm apart from each other and the housing case 4 is 40 mm thick, so that the housing case 4 can be easily placed between wall materials close to each other. Besides, even if the ceramic-type loudspeaker 2 is continuously in operation for a long time, heat is not generated anywhere in the circuit so that the building can be prevented from catching fire.

By the way, for example, there is an approach in which four ceramic piezoelectric elements are used, and realizing a high impedance (e.g., a 100-volt line) is put to practical use by utilizing the idea of a conventional low-frequency matching transformer. However, in the existing low-frequency matching-transformer theory, this approach has been thought to be difficult by those skilled in the art.

If a conventional matching transformer is connected to the speaker drive of a ceramic vibrator, the impedance which would be remarkably lower as the ceramic vibrator's frequency rises can turn into a moderate curve (i.e., a rated approximation). However, the ceramic vibrator's natural resonance frequency, a rated capacitance Cd on an equivalent circuit and C1, L1, R1 work complicatedly. In an ordinary transformer, therefore, because of its relation with a speaker driver (i.e., a ceramic-vibrator driver), the impedance within a frequency range of 1 kHz to about 10 kHz drops to one-third, or below, its rated value at 1 kHz. This allows the mean (average) electric power to be far greater than the rating of a loudspeaker, and thus, this is not practical.

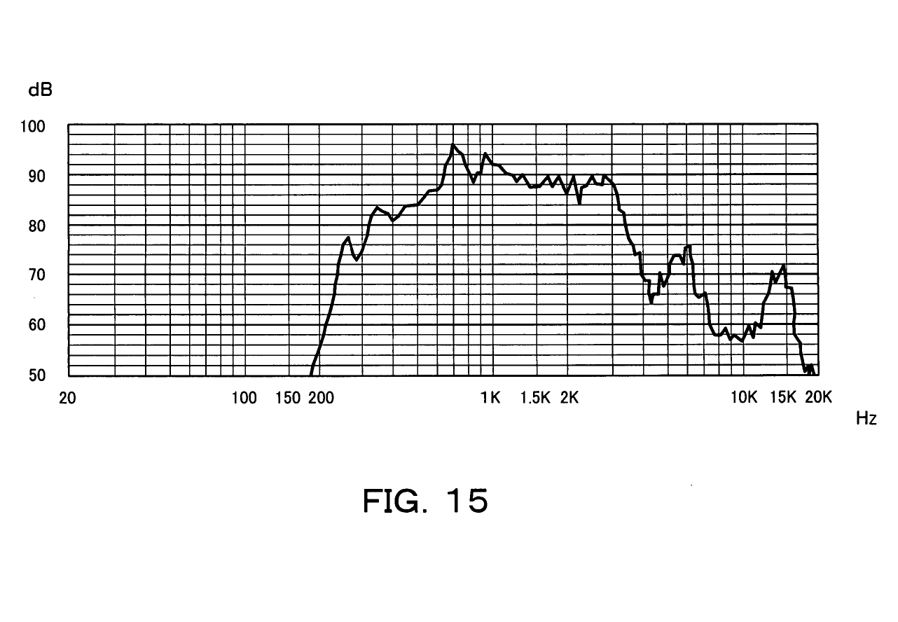

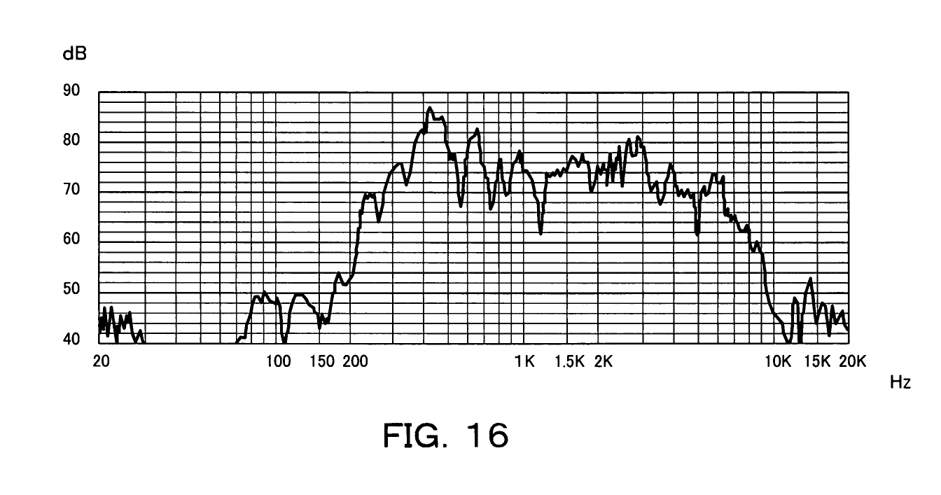

Therefore, in the first stage, the Cd value of a speaker driver is bucked by a choke coil. Thereafter, even if the impedance thought to be the resistance R1 is wound for matching on the secondary side of a conventional transformer, the sound-pressure level is not raised at all (at around 70 dB). Next, in the second stage, attention is given to the fact that the leakage inductance is reduced, and then, the Cd value is moderately bucked through the transformer's overall characteristics. Specifically, two transformers which have various characteristics are connected in series, so that the transformers' overall characteristics (i.e., reducing the leakage inductance) can be ascertained. Then, the frequency characteristics are narrowed within a necessary band, so that their resonance frequency with the ceramic vibrator can be adjusted to approximately 2 kHz. As a result, a characteristic relation between the sound-pressure level and the frequency, which is currently most preferable, can be obtained (see FIG. 15 and FIG. 16 shown later).

In the first matching transformer 45 according to this embodiment, the impedance on the primary side is

Z: 73.55 KΩ

Lp: 6.90 H

while the impedance on the secondary side is

Z: 53.32 KΩ

Ls: 4.90 H

Hence, the frequency band is narrower than that of the second matching transformer 46, but this is because the inductance component on the secondary side of the first matching transformer 45 is increased by several henries. However, if the voltage ratio seen from the primary side is lowered by reducing the number of coil windings on the secondary side, the voltage applied to the ceramic vibrator becomes lower. This makes it difficult for the ceramic-type loudspeaker 2 to obtain a standard (ruled) sound-pressure level as a loudspeaker for emergency addressing.

On the other hand, in the second matching transformer 46, the impedance on the primary side is

Z: 53.2 KΩ

Lp: 5.31 H

while the impedance on the secondary side is

Z: 27.60 KΩ

Ls: 2.67 H

The second matching transformer 46 has a frequency band wider than that of the first matching transformer 45 and is about −3 dB at 12 kHz. It is especially superior in high-frequency characteristics. This seems to come from the fact that the inductance component on the secondary side of the second matching transformer 46 is less. The high-frequency characteristic of an audio signal inputted in the first matching transformer 45 is restricted to 8 kHz, −13 dB. Hence, even if the second matching transformer 46 has a wide frequency characteristic, the loudspeaker's overall frequency characteristic narrows to a range of 300 Hz to some 6 kHz. In the first, second matching transformers 45, 46 according to this embodiment, however, using the two transformers, the frequency band is deliberately narrowed down to the audio band. This contributes toward maintaining the voltage given to the ceramic vibrator, so that importance can be attached limitedly to the sound pressure. If the two first, second matching transformers 45, 46 are connected in series, a match can be made between the drive unit such as an amplifier which drives the first to fourth ceramic vibrators 25 to 28 and the first to fourth ceramic vibrators 25 to 28. Besides, the loudspeaker becomes thinner and smaller than in the case where a single matching transformer is used. At the same time, the leakage inductance can be reduced to the utmost.

Such a speaker driver 50 as described above has a characteristic suitable to drive the first to fourth ceramic vibrators 25 to 28. The ceramic-type loudspeaker 2 has an optimum characteristic relation, as shown in FIG. 15 or FIG. 16, between the sound-pressure level and the frequency. Herein, FIG. 15 is a graph obtained by measuring the ceramic-type loudspeaker 2 placed in a JIS standard box. FIG. 16 is a graph obtained by measuring the ceramic-type loudspeaker 2 attached to a 9.5 mm gypsum board and a 12 mm rock-wool sound-absorbing plate. In this embodiment, the two first matching transformer 45 and second matching transformer 46 are connected in series with each other. Thereby, a preferred frequency characteristic is obtained within a desirable band of 300 Hz to 5.5 kHz. Particularly, the effective frequency which is the regeneration band of the first to fourth ceramic vibrators 25 to 28 is adjusted to around 2 kHz. As a result, an extremely desirable sound-pressure level and frequency characteristic can be obtained. In contrast, if a match is attempted using a single matching transformer between the drive unit such as an amplifier which drives the first to fourth ceramic vibrators 25 to 28 and the first to fourth ceramic vibrators 25 to 28, then the sound pressure and frequency range cannot be secured.

The regeneration band used in the ceramic-type loudspeaker 2 is between 300 Hz and 5.5 kHz. Within this regeneration band, a difference ΔdB between the maximum sound-pressure level and the minimum sound-pressure level is approximately 20 dB. This satisfies the sound-pressure level and frequency characteristic required by the Fire Services Law.

The ceramic-type loudspeaker 2 according to this embodiment is stuck, using the double-faced adhesive tape 12, on the back surface of the building material 1 in a construction structure. Specifically, one side of the double-faced adhesive tape 12 is glued and fixed to the surfaces of the six circular convex portions 15 to 20 which are disposed in the front-side housing portion 5 of the housing case 4. Then, the other side of the double-faced adhesive tape 12 is also glued and fixed to the back surface of the building material 1. In this case, the building material's 1 back surface is wiped clean with a piece of cloth or the like. Thereafter, using the double-faced adhesive tape 12, the ceramic-type loudspeaker 2 is securely pasted onto the building material's 1 back surface.

Herein, attention should be paid to the position where the ceramic-type loudspeaker 2 is attached to the building material 1. It is designed to be put in a position deviated from the middle portion 9 of the building material 1, in other words, in a position where, when the surface of the building material 1 is hit with a rubber hummer or the like, its natural vibration frequency is less frequently generated. This is aimed at preventing the building material 1 from vibrating at the natural vibration frequency when a sound is produced by driving the speaker driver 50 of the ceramic-type loudspeaker 2.

In this way, the ceramic-type loudspeaker 2 is glued and fixed, using the double-faced adhesive tape 12, to the building material's 1 back surface. Thereby, a sound to be produced from the ceramic-type loudspeaker 2 is transmitted to the building material 1, so that it seems as if the building material 1 itself were directly vibrating. In other words, it functions as a sound producing body. Hence, in the ceramic-type loudspeaker 2, there is no need to provide a protective net or the like when embedded in a ceiling because a diaphragm is exposed to the inside of a room, as is the case with a conventional one. This makes it possible to realize an elaborately-designed architectural space. In other words, the ceramic-type loudspeaker 2 is not seen on the inside of a room, or from another such place, so that the room's appearance and design can be prevented from being spoiled. Besides, the ceramic-type loudspeaker 2 does not appear on the inside of a room, and thus, it is superior in dust-proofing and moisture-proofing. Hence, it can also be most suitably used, for example, in a clean room, a bathroom or the like.

Furthermore, when installing the ceramic-type loudspeaker 2, all you have to do is to stick the ceramic-type loudspeaker 2 onto the back surface of the building material 1. Therefore, it can be easily attached to the back surface of the building material 1, such as a ceiling, a panel wall, a pane of glass and a floor.

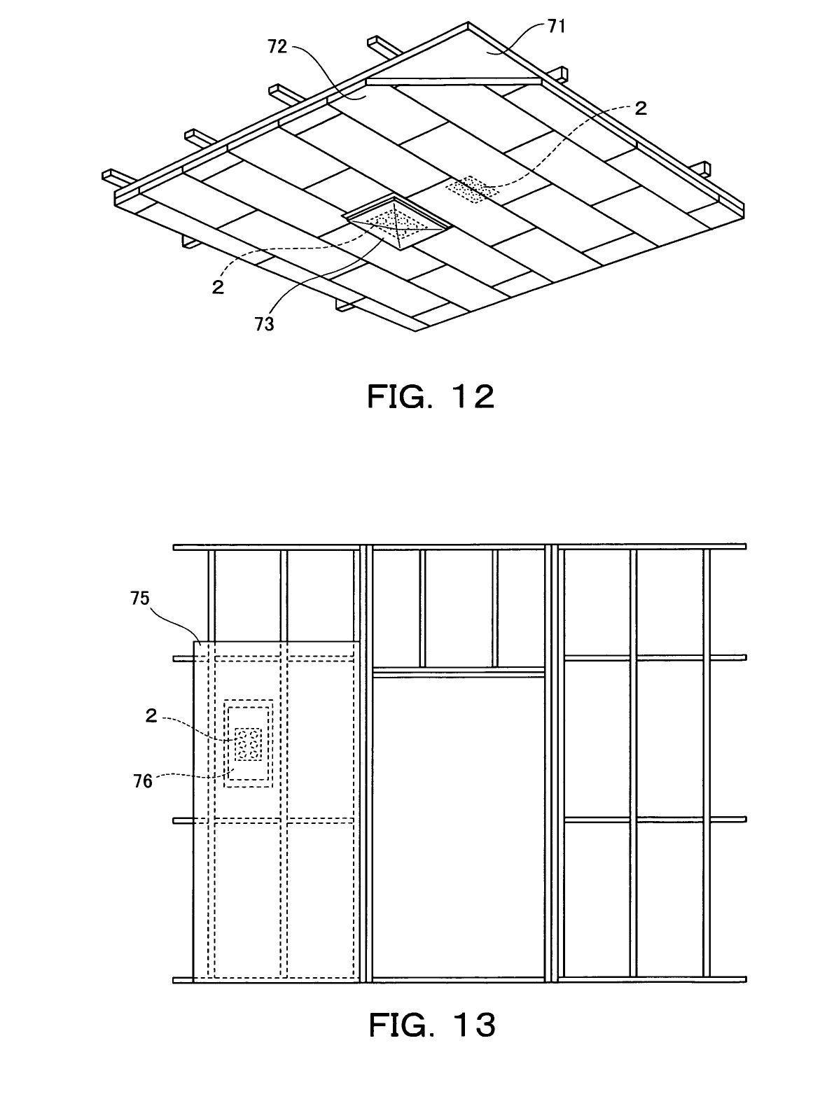

For example, as shown in FIG. 12, the ceramic-type loudspeaker 2 is installed in a ceiling board (e.g., a rock-wool sound-absorbing plate) 72 attached to the lower surface of a base board 71. In this case, the ceramic-type loudspeaker 2 can be installed in a position at or near an inspection hole 73 and a little away from the middle of the ceiling board 72. Thereby, the ceramic-type loudspeaker 2 can be easily attached, maintained and inspected, and at the same time, the ceiling board 72 can be restrained as much as possible from vibrating at its natural vibration frequency.

Moreover, as shown in FIG. 13, when the ceramic-type loudspeaker 2 is attached to a panel-wall surface 75 subjected to gypsum-board finishing (such as a cloth), such attachment is not limited to the panel-wall surface 75. The ceramic-type loudspeaker 2 can be attached to the back surface of an inspection open-and-shut plate (an inspection hole) 76. In this case, the ceramic-type loudspeaker 2 can be more easily inspected.

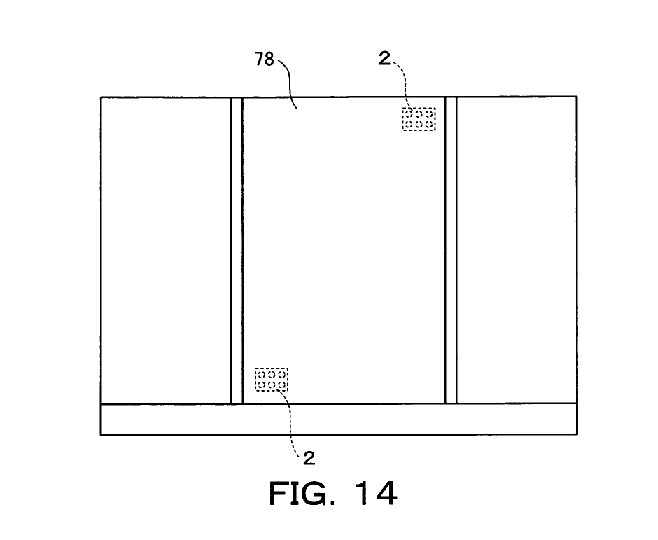

In addition, as shown in FIG. 14, the ceramic-type loudspeaker 2 can be attached to a glass surface 78 or the like which is located between a ceiling and a floor. In terms of its material, a gypsum board, a rock-wool absorbing plate, a piece of timber, a pane of glass, a metal panel or the like can be used, as long as it can vibrate. To the back surface of such an ordinary building material 1, it can be glued, using a dedicated double-faced adhesive tape. In other words, in the ceramic-type loudspeaker 2 according to the present invention, the kind of the building material 1 such as a ceiling material, a wall material and a glass material is not especially limited.

Furthermore, where the ceramic-type loudspeaker 2 should be installed is not especially limited, and thus, it is optional. Particularly, the housing case 4 of the ceramic-type loudspeaker 2 is molded out of a heat-resistant resin such as an ABS resin. This helps strengthen the housing case 4 itself. Besides, the ceramic-type loudspeaker 2 is attached to the back surface of the building material 1. Hence, compared with any conventional loudspeaker, it is far superior in impact-resistance, dust-resistance, chemical-resistance, waterproofing and the like. Thus, it can be installed in any environments. In addition, no magnet is used, so that it can be applied to a clean room of a precision-instrument factory or an intensive care unit of a hospital for which dust or a magnet field is undesirable, or a swimming pool, a public bathhouse or the like which requires waterproofing. Further, there is no need to make a hole in a building material. Hence, it can be easily attached to a building material already provided, thus helping conduct its installation well.

Moreover, in this ceramic-type loudspeaker 2, an installation member itself which is attached to a wall material, a ceiling member, a show window or the like emits a sound directly. Therefore, a broadcast sound can be transmitted uniformly and clearly all over the room space where it is installed. As a matter of course, it can be widely applied to any of business-purpose addressing, emergency addressing and the like.

In addition, the ceramic-type loudspeaker 2 is light and compact, specifically, its total weight is 680 grams and its size is 176×210×40 mm. Then, the crimp connector 13 is used, so that a connection can be made through an easy and simple insertion. This makes it easy to install the ceramic-type loudspeaker 2. Besides, if an exchange is made for an acoustic system in which the ceramic-type loudspeaker 2 is used, then in terms of an amplifier and the like which are used as a broadcasting unit, conventional ones can be used. Hence, even if an acoustic system is replaced, that can be carried out at a low cost and with ease.

As described so far, the ceramic-type loudspeaker 2 according to the present invention is configured by: a vibrator which is formed by housing a piezoelectric vibrator in a heat-resistant resin case; and a diaphragm (a building material) which corresponds to the corn paper of a conventional loudspeaker. Therefore, this case is glued to the back surface of the building material, and thus, a vibration is transmitted directly to the building material. This makes it possible to radiate a stable-loudness sound uniformly all over the inside of a room.

The present invention is not limited to the above described embodiment. For example, in this embodiment, the case is described where a ceramic-type loudspeaker is attached to a building material of an ordinary construction structure. However, it can be attached to the back surface or the like of a wall material of a construction structure (including a mobile body) which has a large seating capacity, such as an outdoor hall, a sports stadium, a ship and a train. This helps output emergency addressing or the like clearly from the invisible loudspeaker.

Furthermore, a gluing surface (i.e., a convex portion) provided in the front of a speaker case is flat, but if the back surface of a building material has a curved-surface portion, the gluing surface of a housing case which corresponds to this can also be shaped like a curved surface. In this case, a convex portion or a concave portion not necessarily has to be provided in the housing case's front part. The whole or a part of the outside surface of the housing case can also be glued to the building material's back surface, by means of a suitable adhesive such as an adhesive agent.

Moreover, in the above described embodiment, the ceramic-type loudspeaker is described as a high-impedance type. However, naturally, the ceramic-type loudspeaker according to the present invention can also be used as a low-impedance type.

Incidentally, in terms of the present invention, numerous variations can be expected without departing from the scope of the present invention. Then, it is a matter of course that the present invention covers such variations.

### DESCRIPTION OF THE SYMBOLS

1: building material
2: ceramic-type loudspeaker (ceramic-board loudspeaker unit)
3: space portion
4: housing case (speaker case)
5: front-side (vibrator attachment-side) housing portion
6: back-side (transformer attachment-side) housing portion
7: rated-value indication label
8: caution-item indication label
9: middle (center) portion
10: screw hole
11: connection screw
12: double-faced adhesive tape
14: screw through hole
15 to 20: circular convex portions
21 to 24: vibrator attachment portions
25 to 28: first to fourth ceramic vibrators
31: attachment hole
32: machine screw
33A: spring washer
33B: plain washer
33C: washer for ceramics
33D: bush for ceramics
34: rubber damper (elastic body)
36, 37: holes for clamping a lead wire
38, 39: lead wires
41: hardening silicone
42: jumper wire
44: printed wiring board
45: first matching transformer (first transformer)
46: second matching transformer (second transformer)
47: fixing screw
48: manufacturing secret-number indication portion
50: speaker driver
51: primary winding
52: core
53: secondary winding
54: primary winding
55: core
56: secondary winding
58: one-touch terminal block
59a, 59b: lead wires
60a, 60b: crimp connectors
62a, 62b: crimp connectors
63a, 63b: cables
64a, 64b: crimp connectors
66a, 66b: crimp connectors
67, 68: crimp connectors
69: serial-parallel circuit portion
71: base board
72: ceiling board (rock-wool sound-absorbing plate)
73: inspection hole
75: panel-wall surface
76: open-and-shut plate (inspection hole)
78: glass surface (glass portion)

1. A ceramic-type loudspeaker which is driven by a drive unit that outputs an audio signal, characterized by including:
a speaker driver which is formed by electrically connecting the primary side of a second transformer in series with the secondary side of a first transformer in which an audio signal is inputted from the drive unit; and
a serial-parallel circuit portion which is formed by connecting a plurality of series circuits in parallel, the plurality of series circuits being formed by connecting, in series, ceramic vibrators driven through an audio signal from the secondary side of the second transformer of the speaker driver,
the speaker driver making an impedance match between the drive unit and the serial-parallel circuit portion.

2. The ceramic-type loudspeaker according to claim 1, characterized in that the first transformer and the second transformer are housed in a speaker case, and both transformers are disposed in places different from each other on the same plane of the speaker case.

3. The ceramic-type loudspeaker according to claim 2, characterized in that the speaker case is disposed in a building material of a building, each ceramic vibrator is attached to the inside of the front portion of the speaker case, the speaker driver is attached to the inside of the back portion of the speaker case, and the front portion of the speaker case is attached to the building material.

4. The ceramic-type loudspeaker according to claim 3, characterized in that the front portion of the speaker case is attached to the building material, using a double-faced adhesive tape.

5. The ceramic-type loudspeaker according to claim 2, characterized in that the ceramic vibrators are individually disposed in a plurality of places inside of the front portion of the speaker case.

6. The ceramic-type loudspeaker according to claim 3, characterized in that the ceramic vibrators are individually disposed in a plurality of places inside of the front portion of the speaker case.

7. The ceramic-type loudspeaker according to claim 4, characterized in that the ceramic vibrators are individually disposed in a plurality of places inside of the front portion of the speaker case.
